(19) United States
(12) Patent Application Publication
(10) Pub. No.: US 2026/0086568 A1
(43) Pub. Date: Mar. 26, 2026

(54) TRANSPORT ROBOT AND ROBOT SYSTEM

(71) Applicant: KAWASAKI JUKOGYO KABUSHIKI KAISHA, Kobe-shi (JP)

(72) Inventors: Yasunori OYAMA, Hyogo (JP); Yoshitaka MURAMATSU, Hyogo (JP); Takashi KIMURA, Hyogo (JP); Takuya ICHISE, Hyogo (JP)

(73) Assignee: KAWASAKI JUKOGYO KABUSHIKI KAISHA, Kobe-shi (JP)

(21) Appl. No.: 19/337,563

(22) Filed: Sep. 23, 2025

(30) Foreign Application Priority Data
Sep. 24, 2024 (JP) 2024-164990

(51) Int. Cl. G05D 1/633; G05D 1/243; G05D 1/246; G05D 1/648; G05D 105/45; G05D 107/70

(52) U.S. Cl. CPC G05D 1/633; G05D 1/243; G05D 1/246; G05D 1/648; G05D 2105/45; G05D 2107/70

(57) ABSTRACT

A transport robot includes: a traveling mechanism; an obstacle sensor that has a two-dimensional detection region along a direction of travel, and that detects a surrounding obstacle; a human detection unit that has a three-dimensional detection region extending around the transport robot, and that detects a surrounding person; and a controller. The controller controls the traveling mechanism to cause the transport robot to travel autonomously to a predetermined work area. The controller controls the traveling mechanism to cause the transport robot to decelerate or stop when an obstacle is detected by the obstacle sensor while the transport robot is traveling autonomously or when a person is detected by the human detection unit while the transport robot is traveling autonomously.

### CROSS-REFERENCE TO RELATED APPLICATION

This application claims priority to Japanese Patent Application No. 2024-164990 filed on Sep. 24, 2024, the entire disclosure of which is incorporated herein by reference.

### BACKGROUND

A robot system is known in which a transport robot travels inside a factory building while carrying a workpiece. Such a robot system is used, for example, in automobile body assembly lines. For example, an automatic guided vehicle (AGV) or an autonomous mobile robot (AMR) is employed as the transport robot.

In conventional facilities, the travel area for an autonomous traveling device is defined. In the facilities, a human detection sensor or a camera is installed near doors through which people enter and exit. When a person is detected entering through a door, a travel-restricted area for the autonomous traveling device is set based on the position of that door.

### SUMMARY

In a conventional autonomous traveling device, the following operations are performed when a person is detected entering its travel area through a door: (1) setting a region around the door as a travel-restricted area, (2) setting, for the autonomous traveling device that is supposed to pass through the travel-restricted area, a travel route that avoids the travel-restricted area, and (3) setting the travel speed of the autonomous traveling device to a speed lower than that during normal operation.

However, even if a travel-restricted area is uniformly set in response to detection of entry of a person, it is difficult to predict the range of movement of the person. To ensure sufficient safety, the travel-restricted area can be expanded. However, this may also affect transport robots that could otherwise continue operating, which in turn may hinder work efficiency in the factory.

The technology disclosed herein relates to a transport robot that travels autonomously. The transport robot includes: a traveling mechanism that causes the transport robot to travel; an obstacle sensor that has a two-dimensional detection region along a direction of travel, and that detects a surrounding obstacle; a human detection unit that has a three-dimensional detection region extending around the transport robot, and that detects a surrounding person; and a controller that controls the traveling mechanism to cause the transport robot to travel autonomously to a predetermined work area, and that controls the traveling mechanism to cause the transport robot to decelerate or stop when an obstacle is detected by the obstacle sensor while the transport robot is traveling autonomously or when a person is detected by the human detection unit while the transport robot is traveling autonomously.

### BRIEF DESCRIPTION OF THE DRAWINGS

FIG. 1 shows part of an automobile manufacturing factory in which a robot system is installed.

FIG. 2 is a perspective view of a work area.

FIG. 3 is a rear view of the work area.

FIG. 4 is a block diagram of the robot system.

FIG. 5 is a block diagram of a transport robot.

FIG. 6 is a plan view showing detection areas of obstacle sensors and human detection units.

FIG. 7 is a rear view showing the detection areas of the obstacle sensors and the human detection units.

FIG. 8 is a flowchart of control of the transport robot.

FIG. 9 is a plan view showing other detection areas of the obstacle sensors and the human detection units.

### DETAILED DESCRIPTION OF THE DRAWINGS

Hereinafter, an embodiment of a robot system and a workpiece transport method using a robot will be described with reference to the drawings. The robot system and the transport method described herein are merely by way of example.

### Overall Structure of Robot System

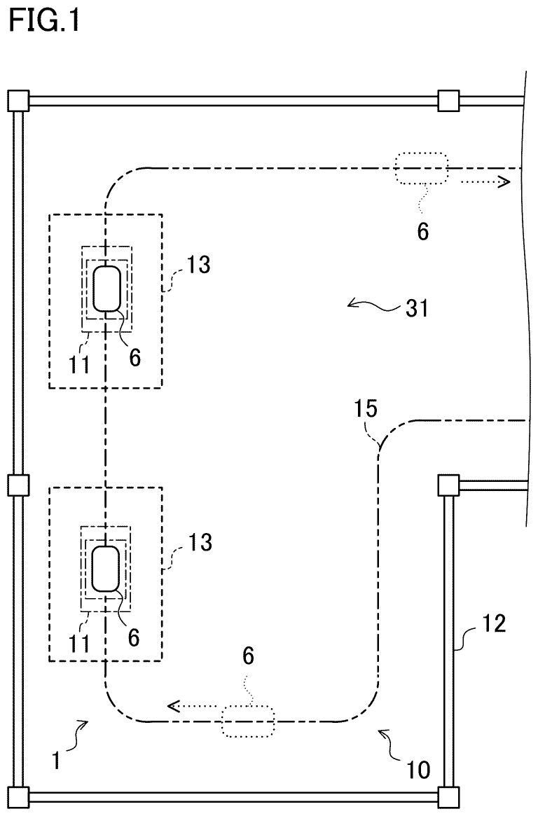

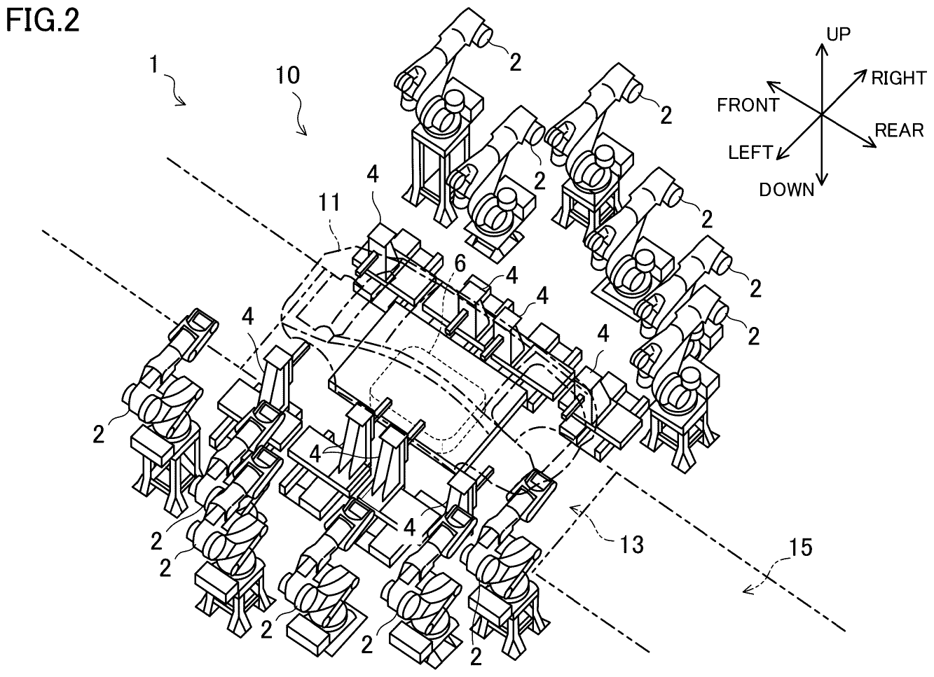

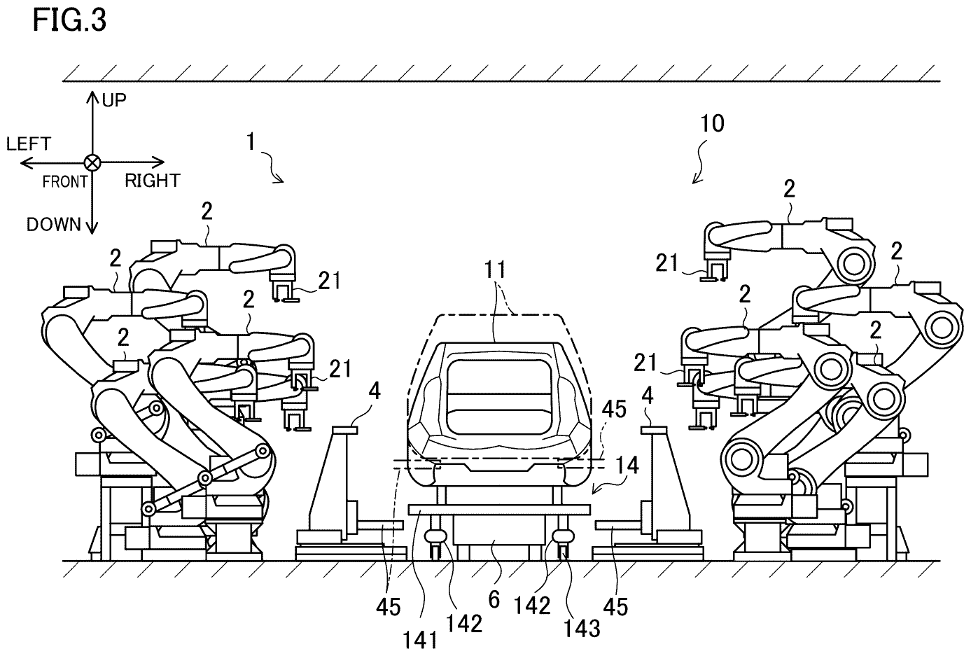

FIG. 1 shows part of an automobile manufacturing factory to which a robot system 1 is applied. FIG. 2 illustrates a work area 13 in the manufacturing factory where operations are performed on a workpiece. FIG. 3 shows the work area 13 as viewed from an angle different from that in FIG. 2.

A building 12 of the manufacturing factory is equipped with a production line 10. The inside of the building 21 is an example of a specific area. In the illustrated example, the production line 10 is a line where welding, more specifically, spot welding, is performed on a body 11 of an automobile. The workpiece is the body 11.

The robot system 1 is installed on the production line 10. The robot system 1 includes an autonomous transport robot 6 described later. On the production line 10, the body 11 is transported by the transport robot 6. The work area 13 refers to the area where the workpiece transported by the transport robot 6 remains to undergo an operation. The work area 13 is part of the production line 10. In the illustrated example, the production line 10 includes two work areas 13. However, the number of work areas 13 in the production line 10 is not limited to any particular number.

The front, rear, right, left, top, and bottom of the robot system 1 are defined as follows with respect to the body 11 that is to undergo operations in the work area 13. The front of the robot system 1 is the upper left side in the direction connecting the lower right side and the upper left side of FIG. 2. The front of the robot system 1 corresponds to the front of the body 11, and the rear of the robot system 1 corresponds to the rear of the body 11. As will be described later, the longitudinal direction corresponds to the direction in which the body 11 is transported. The right side of the robot system 1 is the upper right side in the direction connecting the lower left side and the upper right side of FIG. 2. The right side of the robot system 1 corresponds to the right side of the body 11. The left side of the robot system 1 corresponds to the left side of the body 11. The lateral direction is the horizontal direction perpendicular to the longitudinal direction. The top of the robot system 1 is the upper side of FIG. 2, and the bottom of the robot system 1 is the lower side of FIG. 2. The top and bottom of the robot system 1 correspond to the top and bottom of the body 11. The vertical direction is the vertical direction perpendicular to the longitudinal direction. These definitions are used for the description of the robot system 1, and are not intended to limit the structure or configuration of the robot system 1 and the components of the robot system 1 disclosed herein.

As shown in FIG. 2 or 3, industrial robots 2, 4 are installed in the work area 13. The industrial robots 2, 4 perform spot welding on the body 11 in the work area 13.

Multiple industrial robots 2 are installed in the work area 13. The industrial robots 2 are positioned on both sides of the body 11. Specifically, multiple industrial robots 2 are arranged along the longitudinal direction of the body 11 on the right side of the body 11, and multiple industrial robots 2 are also arranged along the longitudinal direction of the body 11 on the left side of the body 11. The industrial robots 2 perform an operation on the body 11 transported into the work area 13 as a workpiece. The operation performed by the industrial robots 2 on the body 11 is welding. The industrial robots 2 perform welding at respective positions on the body 11. The industrial robots 2 are vertical articulated robots with five to seven axes. As shown in FIG. 3, each industrial robot 2 includes a welding gun 21 as an end effector. However, the industrial robots 2 are not limited to vertical articulated robots. The number of industrial robots 2 is not limited to any particular number, and the arrangement of the industrial robots 2 is not limited to any specific arrangement.

The industrial robot 4 is a locator 4 that lifts and supports the body 11 during the operation of the industrial robots 2. Multiple locators 4 are installed in the work area 13. The locators 4 are positioned on both sides of the body 11. Each locator 4 is located between the industrial robots 2 and the transport robot 6. The relative arrangement of the industrial robots 2, locators 4, and transport robot 6 in the work area 13 is not limited to the example shown in FIG. 3. In the illustrated example, the locators 4 are three-axis Cartesian robots. Each locator 4 includes a rod 45 that engages with the body 11. The rod 45 extends horizontally, and the distal end of the rod 45 engages with the body 11. Each locator 4 changes the position of the distal end of its rod 45 in the longitudinal, lateral, and vertical directions.

The robot system 1 includes one or more transport robots 6. The transport robot 6 transports a workpiece into the work area 13. The transport robot 6 travels on the flat floor surface of the factory. As shown in FIG. 3, the body 11 is placed on a transport platform 14. The transport robot 6 is positioned under the transport platform 14 and engages with the transport platform 14. The transport robot 6 transports the body 11 via the transport platform 14.

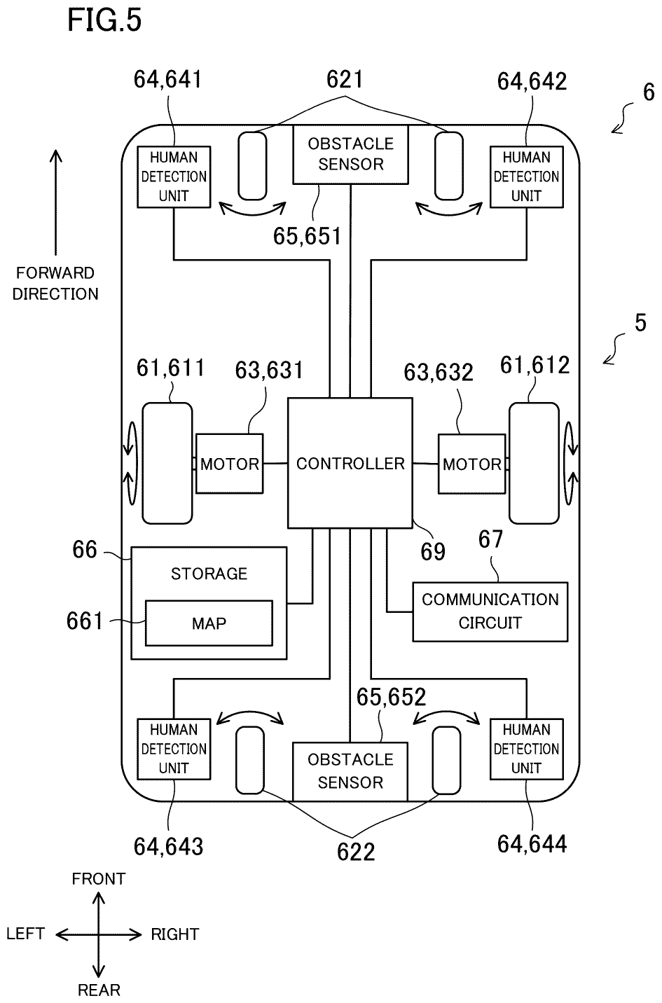

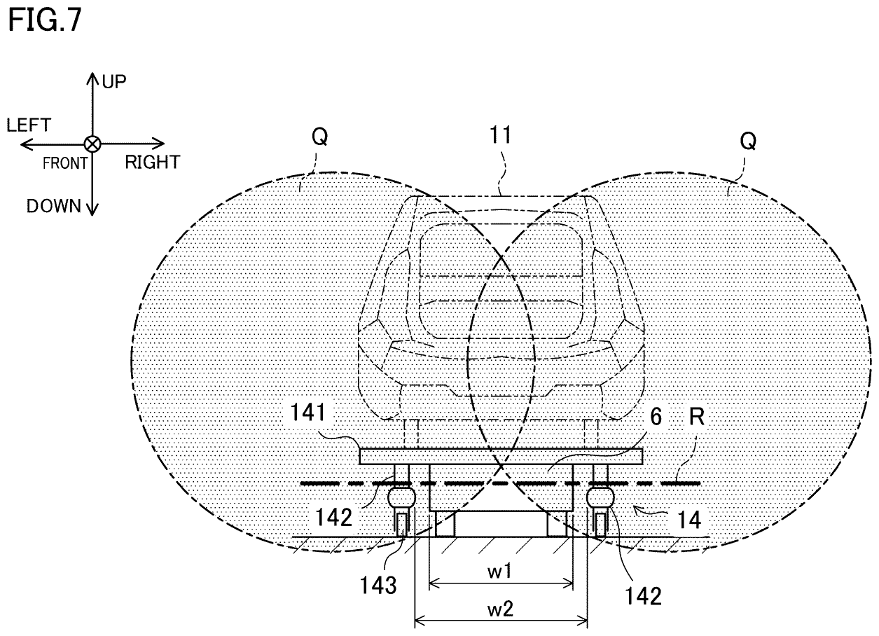

The transport platform 14 includes a base 141 that supports the body 11, and legs 142 that support the base 141. In the illustrated example, the base 141 is a plate member that is rectangular as viewed in plan. However, the shape of the base 141 is not limited to a rectangle as viewed in plan. For example, the base 141 may be circular as viewed in plan. The base 141 may be any member as long as it can support the body 11, and the base 141 need not necessarily be a plate member. As shown in FIGS. 3 and 5, the transport platform 14 includes four legs 142 that extend downward from the four corners of the base 141 to support the base 141. Each leg 142 has, at its lower end, a caster 143 that rolls on the floor surface. The spacing between the legs 142 is, for example, greater than the width of a main body 60 of the transport robot 6. For example, the spacing w1 between the right and left legs 142 is greater than the lateral width w2 of the main body 60 of the transport robot 6 (see FIG. 7). Similarly, the spacing between the front and rear legs 142 is greater than the longitudinal width of the main body 60 of the transport robot 6. The transport robot 6 can enter beneath the base 141 through the space between the legs 142. The transport robot 6 includes a substantially flat upper surface, and has a low height that allows the transport robot 6 to be positioned under the transport platform 14. The transport robot 6 may directly support the body 11 without using the transport platform 14. The external appearance of the transport robot 6 shown in FIG. 2 or 3 is merely illustrative. The structure of the transport robot 6 will be described later.

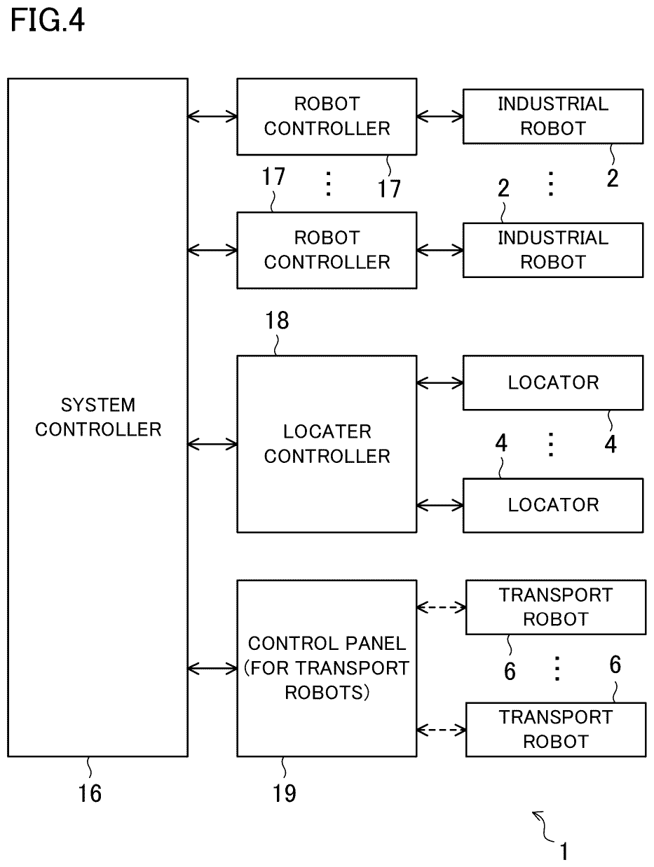

FIG. 4 is a block diagram of the robot system 1. The robot system 1 includes a system controller 16. The system controller 16 controls the entire robot system 1. The robot system 1 may not include the system controller 16.

The robot system 1 includes a robot controller 17. The robot controller 17 is electrically connected to the system controller 16. This electrical connection includes wired or wireless connection. The robot controller 17 is also electrically connected to an industrial robot 2. Robot controllers 17 are connected in a one-to-one-manner to the industrial robots 2. Accordingly, the robot system 1 includes as many robot controllers 17 as industrial robots 2. Each robot controller 17 controls the corresponding industrial robot 2. More specifically, each robot controller 17 receives control signals from the system controller 16 and outputs control signals to the corresponding industrial robot 2. In this example, each industrial robot 2 performs welding on the body 11 in response to the control signals from the corresponding robot controller 17. The robot system 1 may not include the robot controllers 17.

The robot system 1 includes a locator controller 18. The locator controller 18 is electrically connected to the system controller 16. This electrical connection includes wired or wireless connection. The locator controller 18 is also electrically connected to the locators 4. The locator controller 18 controls the locators 4. More specifically, the locator controller 18 receives control signals from the system controller 16 and outputs control signals to the locators 4. In response to the control signals from the locator controller 18, the locators 4 position and support the body 11 delivered from the transport robot 6 at a predetermined position. The robot system 1 may not include the locator controller 18.

The robot system 1 includes a control panel 19 for the transport robot 6. The control panel 19 is electrically connected to the system controller 16. This electrical connection includes wired or wireless connection. The control panel 19 is also electrically connected to the one or more transport robots 6. The control panel 19 controls the transport robots 6. More specifically, the control panel 19 receives control signals from the system controller 16 and outputs control signals to the transport robots 6. The robot system 1 may not include the control panel 19.

### Structure of Transport Robot

The transport robot 6 autonomously travels to transport a workpiece (the body 11 in the illustrated example) to the work area 13. The transport robot 6 may be, for example, an automatic guided vehicle (AGV). An AGV autonomously travels along a magnetic tape on the floor surface to carry the body 11 into the work area 13. AGVs are employed, for example, on automobile body assembly lines. The transport robot 6 may be, for example, an autonomous mobile robot (AMR). An AMR has a simultaneous localization and mapping (SLAM) function. With the SLAM function, the AMR can autonomously travel using a map 661 and an obstacle sensor 65. The use of an AMR eliminates the need for magnetic tape on the floor surface. The following description illustrates an example in which the transport robot 6 is an AMR. However, it is not intended to limit the transport robot 6 to an AMR.

FIG. 5 shows the structure of the transport robot 6. The structure of the transport robot 6 in FIG. 5 is an example of the transport robot 6. A route 15 of the transport robot 6 is not determined in advance, but as shown by the two-dot chain line in FIG. 1, the route 15 has been roughly determined.

The transport robot 6 includes a traveling mechanism 5 that causes the transport robot 6 to travel. The traveling mechanism 5 includes wheels that roll on the floor surface. The wheels include drive wheels 611, 612 and caster wheels 621, 622. The drive wheels 611, 612 are independent. The transport robot 6 is an independently driven transport vehicle. The drive wheel 611 is located on the left side of an intermediate portion in the longitudinal direction of the transport robot 6. The drive wheel 612 is located on the right side of the intermediate portion of the transport robot 6. The rotational axes of the drive wheels 611, 612 extend in the lateral direction and are coaxial. The drive wheel 611 is mechanically connected to a motor 631, and the drive wheel 612 is mechanically connected to a motor 632. The drive wheels 611, 612 can rotate independently of each other.

The motors 631, 632 are driven with electric power supplied from a battery. The battery is mounted on the transport robot 6. The motors 631, 632 are the traction drive source of the transport robot 6. The driving forces of the motors 631, 632 are transmitted to the drive wheels 611, 612 to rotate the drive wheels 611, 612, respectively. In the following description, the motors 631, 632 may be collectively referred to as the motor(s) 63.

When the drive wheels 611, 612 rotate in the same direction at the same rotational speed, the transport robot 6 travels straight ahead. When the drive wheels 611, 612 rotate in the same direction at different rotational speeds, the transport robot 6 changes its direction of travel. When the drive wheels 611, 612 rotate in opposite directions, the transport robot 6 pivots in place, that is, rotates about a vertical axis. In the following description, the drive wheels 611, 612 may be collectively referred to as the drive wheel(s) 61.

The caster wheel 621 is located at the lateral center of the front end of the transport robot 6. The caster wheel 622 is located at the lateral center of the rear end of the transport robot 6. Each of the caster wheels 621, 622 can change its orientation. The transport robot 6 may include one caster wheel. The transport robot 6 may also employ a traveling mechanism other than the drive wheels 61, the caster wheels 621, 622, and the motors 63.

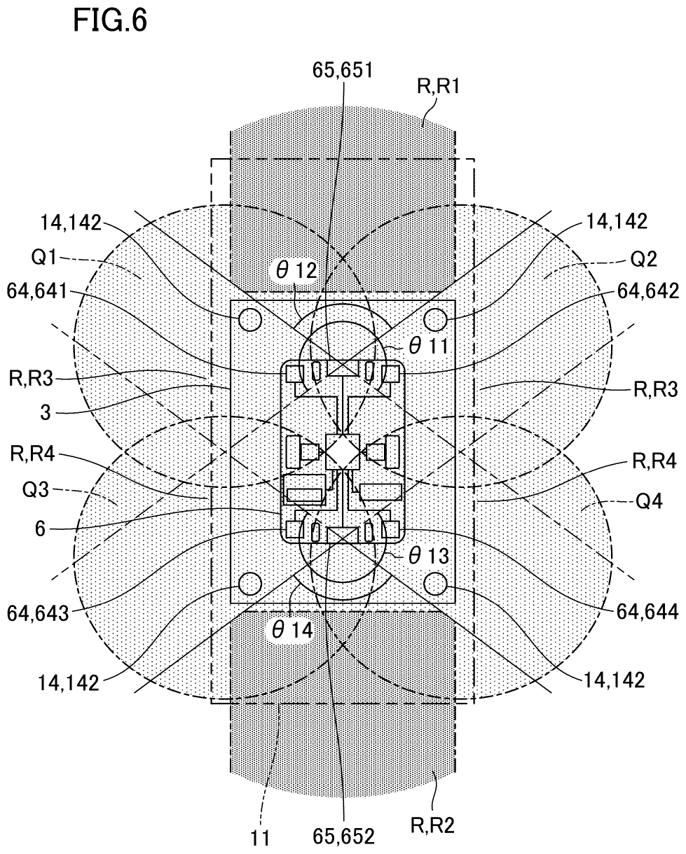

The transport robot 6 includes an obstacle sensor 65. The obstacle sensor 65 is located at both front and rear ends of the transport robot 6 in the longitudinal direction along the direction of travel of the transport robot 6, as viewed in plan. The obstacle sensor 65 detects obstacles in the direction of travel of the transport robot 6. In the present disclosure, the term “obstacle” refers to anything that hinders the travel of the transport robot 6, and specifically, includes objects and people. As shown in FIGS. 6 and 7, the obstacle sensor 65 is a two-dimensional sensor that detects obstacles within a two-dimensional detection region R along the direction of travel of the transport robot 6. The obstacle sensor 65 includes, for example, a two-dimensional Light Detection and Ranging (LiDAR) having the function of a safety laser scanner. As the function of the safety laser scanner, for example, laser light is used to monitor a safety area and detect obstacles. By using a two-dimensional LiDAR as the obstacle sensor 65, cost can be reduced compared to using a three-dimensional LiDAR that can perform three-dimensional detection.

The obstacle sensor 65 includes an obstacle sensor 651 located at the front end of the transport robot 6 and an obstacle sensor 652 located at the rear end of the transport robot 6. In the following description, the obstacle sensors 651, 652 may be collectively referred to as the obstacle sensor(s) 65.

The obstacle sensor 651 detects obstacles in front of the transport robot 6. In FIG. 6, θ11 indicates the detectable range of the obstacle sensor 651. The obstacle sensor 651 has a detectable range greater than 180 degrees in front of the transport robot 6. θ12 indicates, as an angle, the range passing between the two front legs 142 of the transport platform 14 as seen from the obstacle sensor 651. R1 indicates, as a region, the detection range of the obstacle sensor 651. The detection region R1 of the obstacle sensor 651 is, for example, a region within the detectable range of the obstacle sensor 65, located directly in front of the transport robot 6, and passing between the two front legs 142 of the transport platform 14 as seen from the obstacle sensor 651. By setting the detection region R1, the obstacle sensor 651 does not recognize the legs 142 as obstacles. Although not fully shown in FIG. 6 due to space limitations, the detection region R1 extends further forward beyond FIG. 6.

The obstacle sensor 652 detects obstacles behind the transport robot 6. In FIG. 6, θ13 indicates the detectable range of the obstacle sensor 652. The obstacle sensor 652 has a detectable range greater than 180 degrees behind the transport robot 6. θ14 indicates, as an angle, the range passing between the two rear legs 142 of the transport platform 14 as seen from the obstacle sensor 652. R2 indicates, as a region, the detection region of the obstacle sensor 652. The detection region R2 of the obstacle sensor 652 is, for example, a region within the detectable range of the obstacle sensor 652, located directly behind the transport robot 6 and passing between the two rear legs 142 of the transport platform 14 as seen from the obstacle sensor 652. By setting the detection region R2, the obstacle sensor 652 does not recognize the legs 142 as obstacles. Although not fully shown in FIG. 6 due to space limitations, the detection region R2 extends further rearward beyond FIG. 6. In the following description, the detection regions R1, R2 of the obstacle sensors 651, 652 may be collectively referred to as the detection region(s) R.

Referring back to FIG. 5, the transport robot 6 includes a human detection unit 64. The human detection unit 64 detects people to the sides of the transport robot 6. The human detection unit 64 is located at both right and left ends of the transport robot 6 in the lateral direction, as viewed in plan. The human detection unit 64 may be any unit as long as it can detect people, and is not limited to any specific detection device. For example, the human detection unit 64 may include a human detection sensor and a camera. For example, the human detection sensor may be one or more selected from the group consisting of an infrared sensor, an ultrasonic sensor, a microwave sensor, a photoelectric sensor, and a pressure sensor. The camera may be, for example, an infrared camera (including a thermal camera) or a visible light camera using an imaging sensor such as complementary metal-oxide semiconductor (CMOS) or charge coupled device (CCD). The human detection unit 64 may be a device other than the examples described above.

In the example of FIG. 5, the human detection unit 64 includes human detection units 641, 642, 643, and 644. In the following description, the human detection units 641, 642, 643, and 644 may be collectively referred to as the human detection unit(s) 64. The human detection unit 641 is located at the front left corner of the transport robot 6 and detects people located within an area at the front left of the transport robot 6 and the body 11. The human detection unit 642 is located at the front right corner of the transport robot 6 and detects people located within an area at the front right of the transport robot 6 and the body 11. The human detection unit 643 is located at the rear left corner of the transport robot 6 and detects people located within an area at the rear left of the transport robot 6 and the body 11. The human detection unit 644 is located at the rear right corner of the transport robot 6 and detects people located within an area at the rear right of the transport robot 6 and the body 11. The human detection unit 64 is a three-dimensional sensor or a camera that detects people within a three-dimensional detection region around the transport robot 6. In FIG. 6, Q1 indicates the detection region of the human detection unit 641, Q2 indicates the detection region of the human detection unit 642, Q3 indicates the detection region of the human detection unit 643, and Q4 indicates the detection region of the human detection unit 644. In the following description, the detection regions Q1, Q2, Q3, and Q4 of the human detection units 64 may be collectively referred to as the detection region(s) Q.

As shown in FIG. 6, as viewed in plan, when the detection regions R of the obstacle sensors 65 are combined with the detection regions Q of the human detection units 64, a 360-degree detection range around the body 11 is covered. The number of human detection units 64 is not limited to four. For example, two human detection units 64 may be provided at an intermediate position between the front and rear of the main body 60, one on each of the right and left sides. Alternatively, more than four human detection units 64 may be provided.

The transport robot 6 includes a storage 66. The storage 66 stores various types of data. The data stored in the storage 66 include the map 661. Examples of the storage 66 include magnetic recording media such as a hard disk drive (HDD), optical recording media such as a Blu-ray disc and a digital versatile disc (DVD), and semiconductor recording media such as a solid-state drive (SSD), CFAST (registered trademark), and a CompactFlash (CF) card. The map 661 is a map of the inside of the building 12 including the production line 10. The map of the inside of the building 12 may be stored in advance in the transport robot 6. Before the transport robot 6 transports the body 11, the transport robot 6 may autonomously travel inside the building 12 and create the map 661 during travel using the obstacle sensors 65.

The transport robot 6 includes a communication circuit 67. The communication circuit 67 performs wireless communication with the system controller 16. The communication circuit 67 can receive control signals from the system controller 16. The communication circuit 67 can transmit, for example, position information of the transport robot 6 to the system controller 16.

The transport robot 6 includes a controller 69. The controller 69 controls the transport robot 6. The controller 69 is electrically connected to the motors 63, the obstacle sensors 65, the storage 66, and the communication circuit 67. The controller 69 receives control signals from the system controller 16 through the communication circuit 67, and causes the transport robot 6 to perform operations corresponding to the received control signals. The transport robot 6 autonomously travels to a position designated by the system controller 16, namely the work area 13 for the industrial robots 2. When the transport robot 6 travels, the controller 69 sets the route 15 of the transport robot 6 based on the map 661. While the transport robot 6 is traveling, the controller 69 estimates the position of the transport robot 6 based on signals from the obstacle sensors 65 and the map 661. By autonomously traveling along the route 15 to the work area 13, the transport robot 6 transports the body 11 to the work area 13.

### Operation of Transport Robot

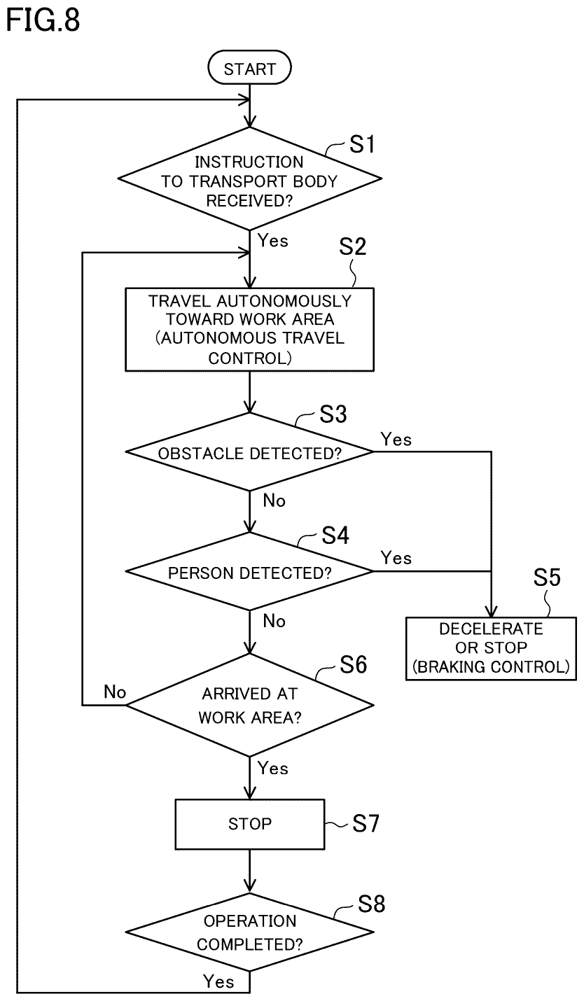

Next, the process performed by the transport robot 6 to transport the body 11 based on the map 661 will be described. FIG. 8 is a flowchart showing control of the transport robot 6.

In step S1, the controller 69 determines whether an instruction to transport the body 11 has been received from the system controller 16 via the communication circuit 67. When the instruction to transport the body 11 is received (Yes in S1), the controller 69 preforms autonomous travel control. In the autonomous travel control, the controller 69 uses the map 661 and the obstacle sensors 65 to cause the transport robot 6 to travel autonomously to the designated work area 13. More specifically, the controller 69 outputs travel control signals to the motors 63 to control the rotational speeds of the drive wheels 61 so that the transport robot 6 travels straight, changes its direction of travel, or pivots (turns) in place. The controller 69 thus controls the transport robot 6 to travel autonomously to the work area 13. Upon receiving the travel control signals, the motors 63 rotate at speeds corresponding to the received travel control signals to drive the drive wheels 61.

Steps S3 and S4 are processes performed during autonomous travel of the transport robot 6. In step S3, while the transport robot 6 is traveling autonomously, the obstacle sensors 65 detect whether there is an obstacle in the direction of travel of the transport robot 6. When no obstacle is detected, the transport robot 6 continue traveling autonomously. On the other hand, when an obstacle is detected by any of the obstacle sensors 65, the controller 69 performs braking control to decelerate or stop the transport robot 6 driven by the traveling mechanism 5 in step S5. More specifically, the controller 69 outputs a braking signal to the motors 63, instructing them to decelerate or stop the transport robot 6. Upon receiving the braking signal, the motors 63 decelerates or stops the drive wheels 61 accordingly. In step S4, while the transport robot 6 is traveling autonomously, the human detection units 64 detect whether there is a person to the sides of the transport robot 6. When no person is detected, the transport robot 6 continue traveling autonomously. On the other hand, when a person is detected by any of the human detection units 64, the controller 69 performs braking control to decelerate or stop the transport robot 6 driven by the traveling mechanism 5 in step S5. More specifically, the controller 69 outputs a braking signal to the motors 63, instructing them to decelerate or stop the transport robot 6. Upon receiving the braking signal, the motors 63 decelerates or stops the drive wheels 61 accordingly. Although the flowchart of FIG. 8 illustrates an example in which steps S3, S4 are performed in series, steps S3, S4 may be processed in parallel. The order of steps S3, S4 may be reversed.

In step S6, the controller 69 determines whether the transport robot 6 has arrived at the work area 13. The transport robot 6 continues traveling autonomously until it arrives at the work area 13. That is, steps S2 to S6 are repeated until the transport robot 6 arrives at the work area 13. When the transport robot 6 arrives at the work area 13, the transport robot 6 stops at a predetermined position in the work area 13 (step S7). Thereafter, the locators 4 operate to receive the body 11 from the transport robot 6.

In step S8, the controller 69 determines whether the operation of the industrial robots 2 has been completed. The transport robot 6 remains stopped until the operation is completed. Once the operation of the industrial robots 2 is completed, the process of FIG. 8 returns to step S1. The controller 69 determines whether the next instruction has been received. When an instruction is received, steps S1 to S8 are repeated.

### Functions and Effects

The transport robot 6 according to the present disclosure decelerates or stops not only when an obstacle is detected around the transport robot 6 by any of the obstacle sensors 65, but also when a person is detected around the transport robot 6 by any of the human detection units 64. The safety of the transport robot 6 can thus be improved.

The obstacle sensors 65 are, for example, two-dimensional sensors that detect obstacles within a two-dimensional detection region along the direction of travel of the transport robot 6. The human detection units 64 are, for example, three-dimensional sensors that detect people within a three-dimensional detection region around the transport robot 6. With this configuration, the obstacle sensors 65 can detect obstacles at a height corresponding to the height of the transport robot 6, and the human detection units 64 can detect movement of obstacles located at positions higher than the upper end of the transport robot 6. That is, the obstacle sensors 65 and the human detection units 64 detect their respective targets. With this configuration, the safety of the transport robot 6 can be improved using a combination of relatively inexpensive sensors.

### Modifications

The system controller 16 may be omitted from the robot system 1. The robot system 1 may perform a welding operation on the body 11 by mutual communication among the robot controllers 17, the locator controller 18, and the transport robot 6.

The operations performed by the robot system 1 on the production line 10 are not limited to welding. The workpiece to be processed by the robot system 1 is not limited to the automobile body 11. The applications of the robot system 1 are not limited to the automobile production line 10. For example, the transport robot 6 may transport a workpiece that has not yet been formed into a body, with the workpiece fixed to a jig. In this case, the industrial robots may perform operations on the transported workpiece, such as drilling with a drill, fastening bolts with a nutrunner, inspecting the workpiece with a camera, or applying an adhesive or sealant with an application device.

In the above embodiment, the human detection units 64 (641, 642, 643, 644) may be cameras connected to a computer such as a server via a network and detecting people within the detection regions Q (hereinafter referred to as “web cameras”). In this case, images from the web cameras during operation of the transport robot 6 (including while the transport robot 6 is traveling) may be transmitted via a network such as the Internet to a cloud server or a personal computer (PC). The cloud server or PC may input the images captured by the web cameras into artificial intelligence (AI) having a machine learning model. The machine learning model may, for example, analyze in real time whether a person is present in an image, or, if a person is present in the image, the distance to the person, and output the analysis results. The transport robot 6 may receive in real time, via the above network etc., information indicating that a person has been detected by the machine learning model, and perform braking control to decelerate or stop the transport robot 6 driven by the traveling mechanism 5. More specifically, the controller 69 of the transport robot 6 may output a braking signal to the motors 63, instructing them to decelerate or stop the transport robot 6. As used herein, “a person is present in an image” includes not only cases where the entire person is captured in the image, but also cases where part of the human body, such as an arm or a leg, is captured in the image.

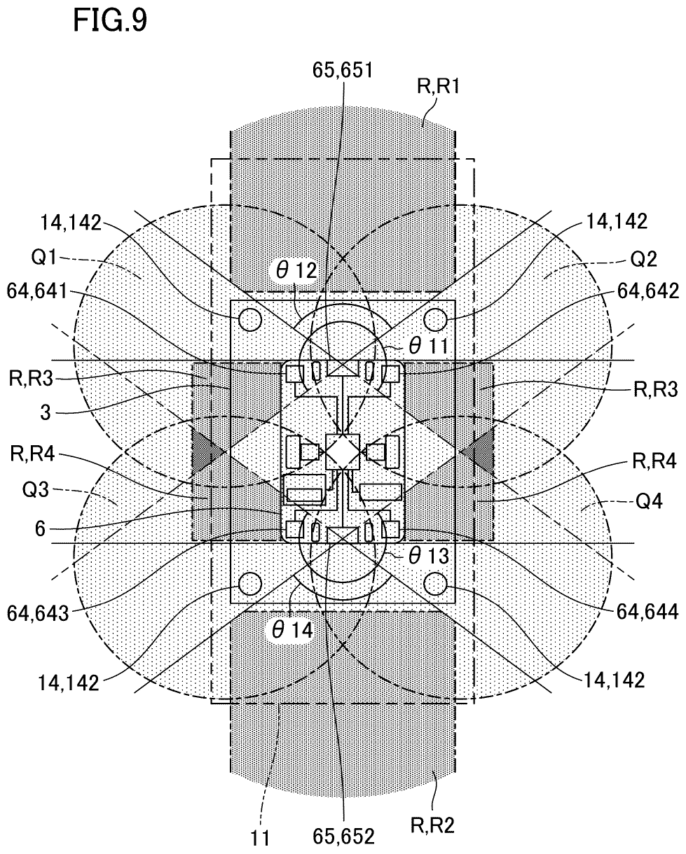

In the above embodiment, the detection region R1 of the obstacle sensor 651 is not limited to the range shown in FIG. 6. For example, as shown in FIG. 9, the detection region of the obstacle sensor 651 may include a detection region R3 in addition to the detection region R1 described above. The detection region R3 is a region within the detectable range of the obstacle sensors 65, located to the side of the transport robot 6 and, as seen from the obstacle sensor 651, not overlapping with the legs 142 located at the front right and left sides of the transport platform 14. Similarly, the detection region R2 of the obstacle sensor 652 is not limited to the range shown in FIG. 6. For example, as shown in FIG. 9, the detection region of the obstacle sensor 652 may include a detection range R4 in addition to the detection region R2 described above. The detection region R4 is a region within the detectable range of the obstacle sensors 65, located to the side of the transport robot 6 and, as seen from the obstacle sensor 652, not overlapping with the legs 142 located at the rear right and left sides of the transport platform 14.

The functionality of the elements disclosed herein may be implemented using one or more circuitry or processing circuitry which includes general purpose processors, special purpose processors, integrated circuits, application-specific integrated circuits (ASICs), field programmable gate arrays (FPGAs) and/or conventional circuitry. The functionality of the elements disclosed herein may be implemented using one or more circuitry or processing circuitry which includes combinations of general purpose processors, special purpose processors, integrated circuits, ASICs, FPGAs, or conventional circuitry. The one or more circuitry or processing circuitry is programmed, using one or more programs stored together or individually in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality, alone or in combination with one another. The hardware may be any hardware disclosed herein which is programmed or configured to carry out the recited functionality.

There is a memory that stores a computer program which includes computer instructions. The computer instructions provide the logic and routines that enable the hardware to perform the method disclosed herein. The hardware includes, e.g., processing circuitry or circuitry. The computer program can be implemented in known formats as a computer-readable storage medium, a computer program product, a memory device, a record medium such as CD-ROM or DVD, and/or the memory of FPGAs or ASICs.

### Aspects

The embodiment described above is a specific example of the following aspects.

### First Aspect

A transport robot (6) that travels autonomously includes: a traveling mechanism (5) that causes the transport robot (6) to travel; an obstacle sensor (65) that has a two-dimensional detection region (R) along a direction of travel, and that detects a surrounding obstacle; a human detection unit (64) that has a three-dimensional detection region (Q) extending around the transport robot, and that detects a surrounding person; and a controller (69) that controls the traveling mechanism (5) to cause the transport robot (6) to travel autonomously to a predetermined work area (13), and that controls the traveling mechanism (5) to cause the transport robot (6) to decelerate or stop when an obstacle is detected by the obstacle sensor (65) while the transport robot (6) is traveling autonomously or when a person is detected by the human detection unit (64) while the transport robot (6) is traveling autonomously.

### Second Aspect

In the transport robot (6) of the first aspect, the obstacle sensor (65) is a light detection and ranging (LiDAR).

### Third Aspect

In the transport robot (6) of the first or second aspect, the human detection unit (64) is one or more sensors selected from the group consisting of an infrared sensor, an ultrasonic sensor, a microwave sensor, a photoelectric sensor, and a pressure sensor.

### Fourth Aspect

In the transport robot (6) of any one of the first to third aspects, the human detection unit (64) detects a person located to the side of the transport robot (6).

### Fifth Aspect

In the transport robot (6) of any one of the first to fourth aspects, the transport robot (6) includes a map (661) of a specific area including the work area (13), and travels autonomously in the specific area while estimating the position of the transport robot (6) using the map (661) and the obstacle sensor (65).

### Sixth Aspect

In the transport robot (6) of any one of the first to fifth aspects, the obstacle sensor (65) is located at front and rear ends of the transport robot (6) in a longitudinal direction along the direction of travel of the transport robot (6), as viewed in plan.

### Seventh Aspect

In the transport robot (6) of any one of the first to sixth aspects, the human detection unit (64) is located at right and left ends of the transport robot (6) in a lateral direction perpendicular to the direction of travel of the transport robot (6), as viewed in plan.

### Eighth Aspect

A robot system (1) includes: an industrial robot (2) installed in a work area (13) where an operation is performed on a workpiece; and a transport robot (6) including an obstacle sensor (65) that detects a surrounding obstacle, and a human detection unit (64) that detects a surrounding person. The transport robot (6) travels autonomously to transport the workpiece to the work area (13). The transport robot (6) decelerates or stops when an obstacle is detected by the obstacle sensor (65) while the transport robot (6) is traveling autonomously or when a person is detected by the human detection unit (64) while the transport robot (6) is traveling autonomously.

In the robot system (1) according to the present disclosure, the transport robot (6) decelerates or stops not only when an obstacle is detected around the transport robot (6) by the obstacle sensor (65) but also when a person is detected around the transport robot (6) by the human detection unit (64). The safety of the transport robot (6) can thus be improved.

### Ninth Aspect

In the robot system (1) of the eighth aspect, the obstacle sensor (65) is a two-dimensional sensor that detects an obstacle within a two-dimensional detection region along a direction of travel of the transport robot (6), and the human detection unit (64) is a three-dimensional sensor that detects a person within a three-dimensional detection region (Q) around the transport robot (6).

### Tenth Aspect

In the robot system (1) of the eighth or ninth aspect, the transport robot (6) includes a map (661) of a specific area including the work area (13), and travels autonomously in the specific area while estimating the position of the transport robot (6) using the map (661) and the obstacle sensor (65).

### Eleventh Aspect

The robot system of any one of the eighth to tenth aspects further includes: a transport platform (14) including a base (141) that supports the workpiece, and legs (142) extending downward from the base (141). The transport platform (14) is transported by the transport robot (6) located under the base (141). A detection region of the obstacle sensor (65) is a region passing between the legs (142) of the transport platform (14) as seen from the obstacle sensor (65).

1. A transport robot that travels autonomously, the transport robot comprising:
a traveling mechanism that causes the transport robot to travel;
an obstacle sensor that has a two-dimensional detection region along a direction of travel, and that detects a surrounding obstacle;
a human detection unit that has a three-dimensional detection region extending around the transport robot, and that detects a surrounding person; and
a controller that controls the traveling mechanism to cause the transport robot to travel autonomously to a predetermined work area, and that controls the traveling mechanism to cause the transport robot to decelerate or stop when an obstacle is detected by the obstacle sensor while the transport robot is traveling autonomously or when a person is detected by the human detection unit while the transport robot is traveling autonomously.

2. The transport robot of claim 1, wherein
the obstacle sensor is a two-dimensional light detection and ranging including a function of a safety laser scanner.

3. The transport robot of claim 1, wherein
the human detection unit is one or more selected from the group consisting of an infrared sensor, an ultrasonic sensor, a microwave sensor, a photoelectric sensor, a pressure sensor, and a camera.

4. The transport robot of claim 1, wherein
the human detection unit detects a person located to a side of the transport robot.

5. The transport robot of claim 1, wherein
the transport robot includes a map of a specific area including the work area, and travels autonomously in the specific area while estimating a position of the transport robot using the map and the obstacle sensor.

6. The transport robot of claim 1, wherein
the obstacle sensor is located at front and rear ends of the transport robot in a longitudinal direction along the direction of travel of the transport robot, as viewed in plan.

7. The transport robot of claim 1, wherein
the human detection unit is located at right and left ends of the transport robot in a lateral direction perpendicular to the direction of travel of the transport robot, as viewed in plan.

8. A robot system comprising:
an industrial robot installed in a work area where an operation is performed on a workpiece; and
a transport robot including an obstacle sensor that detects a surrounding obstacle, and a human detection unit that detects a surrounding person, wherein
the transport robot travels autonomously to transport the workpiece to the work area, and
the transport robot decelerates or stops when an obstacle is detected by the obstacle sensor while the transport robot is traveling autonomously or when a person is detected by the human detection unit while the transport robot is traveling autonomously.

9. The robot system of claim 8, wherein
the obstacle sensor is a two-dimensional sensor that detects an obstacle within a two-dimensional detection region along a direction of travel of the transport robot, and
the human detection unit is a three-dimensional sensor that detects a person within a three-dimensional detection region around the transport robot.

10. The robot system of claim 8, wherein
the transport robot includes a map of a specific area including the work area, and travels autonomously in the specific area while estimating a position of the transport robot using the map and the obstacle sensor.

11. The robot system of claim 8, further comprising:
a transport platform including a base that supports the workpiece, and legs extending downward from the base, wherein
the transport platform is transported by the transport robot located under the base, and
a detection region of the obstacle sensor is a region passing between the legs of the transport platform as seen from the obstacle sensor.
